(19) United States
(12) Patent Application Publication
(10) Pub. No.: US 2007/0185690 A1
(43) Pub. Date: Aug. 9, 2007

(54) Indoor power cord network transmission device

(75) Inventor: Steven Su, Taoyuan (TW)

Correspondence Address: TROXELL LAW OFFICE PLLC, SUITE 1404, 5205 LEESBURG PIKE, FALLS CHURCH, VA, 22041, US

(73) Assignee: Enermax Technology Corporation

(21) Appl. No.: 11/346,331

(22) Filed: Feb. 3, 2006

(51) Int. Cl. G06F 15/00

(52) U.S. Cl. 702/188

(57) ABSTRACT

The present invention discloses a network transmission device that utilizes an indoor power cord as the network transmission media. A router is provided at one end of the network cable. A control chip is provided inside a power supplier. The network cable with router is electrically coupled to the power cord such that after a computer host is connected to the network and connected to the power supplier, the other computer hosts can be connected to the indoor alternating current power cord via the router or the power supplier thereby connected to the Internet.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD OF THE INVENTION

The present invention relates to a network transmission device utilizing an indoor power cord as transmission media. A computer host is first connected to a network cable and then connected to a power cord such that other computer hosts can be connected to the indoor alternating current power cord via a network connector or a power supplier, thereby directly connecting to the Internet.

### BACKGROUND OF THE INVENTION

Conventional personal computers or notebooks are provided with network connecting devices such that computer hosts can be connected to the Internet. The personal computers or notebooks are connected to an alternating current cable via a power cord. A power supplier or transformer will convert the alternating current to regulated direct current with different voltage values so as to supply different voltages needed by each component within the computer hosts or servers.

Therefore, the alternating current power cord and the network cable need to be separately extended to each computer for use and for network connection, causing complicated cabling and configuration costs.

Although wireless network connection has become very common recently, wireless connection requires wireless equipment to achieve such connection, which is an additional configuration cost. Additionally, wireless network connection cannot achieve the desired network connection effect either.

In general, each personal computer or notebook computer host needs to be connected to the alternating current via the power supplier or the transformer disposed thereon. Therefore, it is desired to have the computer host or notebook connected to the alternating current via the power cord, and transmit network signals through the alternating current power cord, thereby saving costs on network configuration and cabling.

### SUMMARY OF THE INVENTION

The present invention discloses a network transmission device that utilizes an indoor power cord as the network transmission media. A router is provided at one end of the network cable. A control chip is provided inside a power supplier. The network cable with router is electrically coupled to the power cord such that after a computer host is connected to the network and connected to the power supply, the other computer hosts can be connected to the indoor alternating power cord via the router or the power supplier thereby connected to the Internet.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a configuration drawing of the indoor power cord network transmission device in accordance with the present invention.

FIG. 2 is a component configuration drawing of the indoor power cord network transmission device, the computer host, and the power supplier in accordance with the present invention.

FIG. 3 is a configuration drawing of another embodiment of the indoor power cord network transmission device in accordance with the present invention.

FIG. 4 is a component configuration drawing of another embodiment of the indoor power cord network transmission device, the computer host, and the power supplier in accordance with the present invention.

### DETAILED DESCRIPTION OF THE EMBODIMENTS

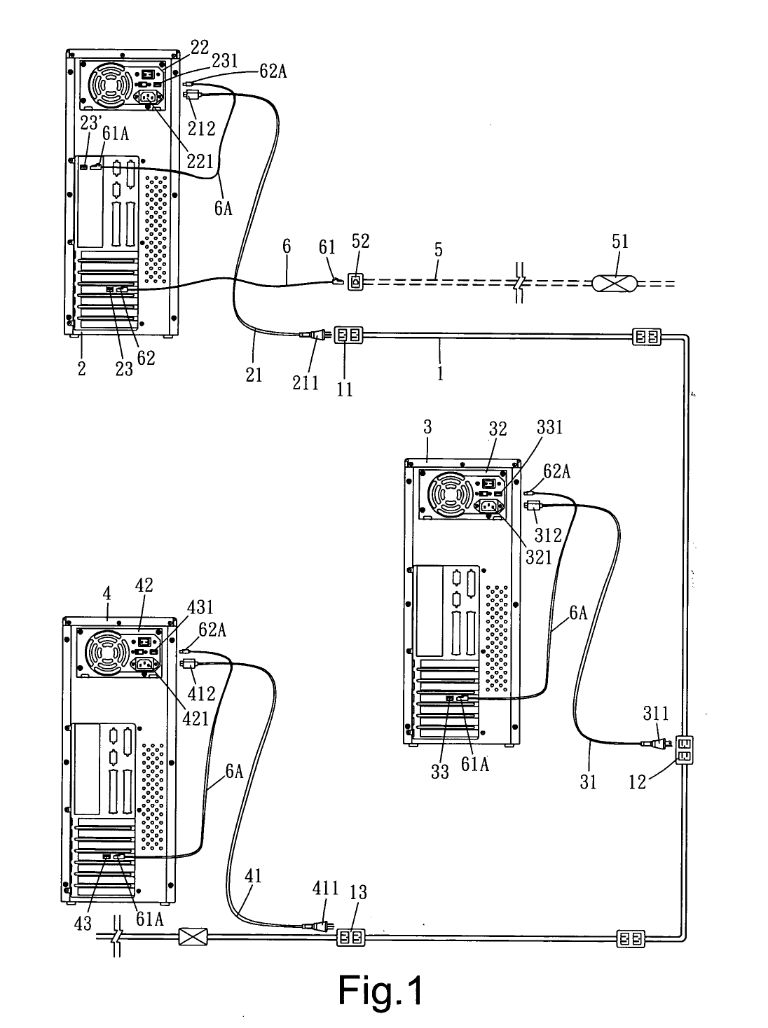

Refer to FIG. 1, which illustrates a configuration drawing of the indoor power cord network transmission device in accordance with the present invention. Alternating current power cable (1) of the present invention extends to the place where respective computer host (2), (3), (4) is disposed. Each computer host (2), (3), (4) is connected to a plug (11), (12), (13) of the alternating power cord (1) via the power plug (211), (311), (411) of the power cable (21), (31), (41). The other connector (212), (312), (412) is connected to the power input end (221), (321), (421) of the power supplier (22), (32), (42) such that the alternating current power cord (1) is connected to the power supplier (22), (32), (42) of the respective computer host (2), (3), (4) and supplies alternating current.

Wherein a housing or panel of the first computer host (2) is provided with at least two network connectors (23), (23′), while the rest of the computer hosts are provided with at least one network connectors (33), (43). Additionally, the power supplier (22), (32), (42) installed on the respective computer host (2), (3), (4) is provided with a network connector (231), (331), (431) respectively.

The network cable (5) of the present invention is provided with a router (51) at one end. The Ethernet network cable (5) is provided with a connector (52) so as to be connected to the connector (52) of the network cable (5) via the connecting end (61) of the network cable (6). A connector (62) at the other end of the network cable (6) is connected to the network connector (23) disposed on the housing or the panel of the first computer host (2), such that the computer host (2) and the network cable (5) are connected.

Additionally, a network cable (6A) is connected to another network connector (23′) of the first computer host (2) via a connecting end (61 A) at one end. A network cable (62A) at the other end of the network cable (6) is connected to the network connector (231) of the power supplier (22) in the computer host (2); as a result, the computer host (2) is connected to the power supplier (22), (32), (42).

The remaining computer hosts (3), (4) also connect the network connector (33), (43) of the computer host (3), (4) to the network connector (331), (431) of the power supplier (32), (42) thereon via the network cable (6A). As a result, the computer hosts (3), (4) are network-connected to the power supplier (32), (42) respectively.

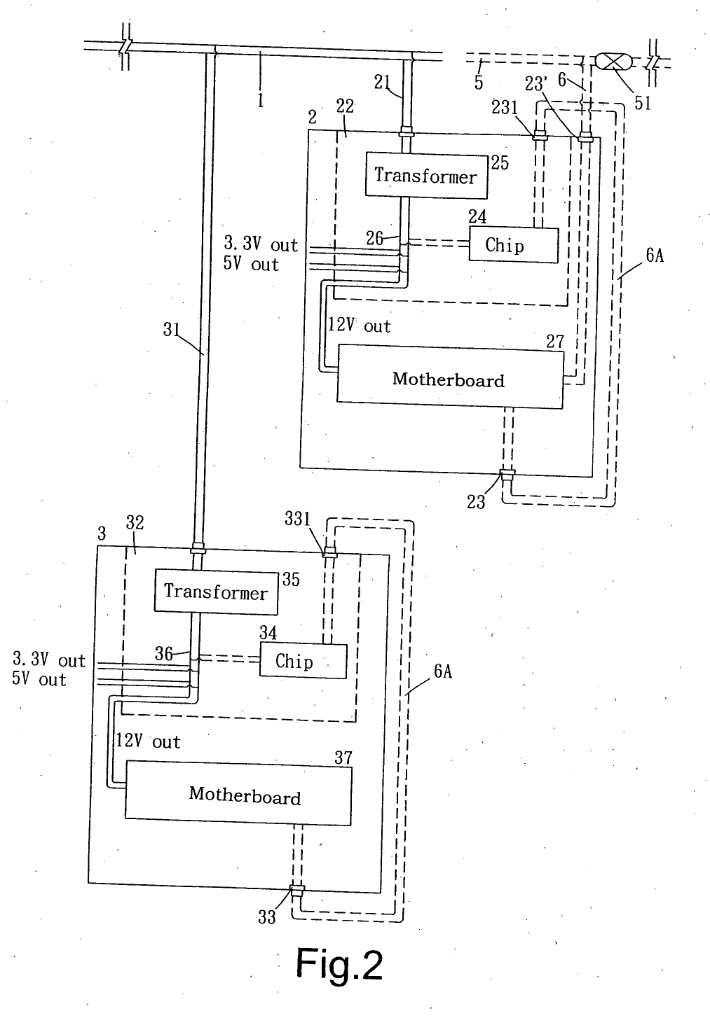

Refer to FIG. 2, which illustrates the component configuration of the indoor power cable network transmission device, the computer host and the power supplier in accordance with the present invention. A control chip 24, 34 is provided within the power supplier (22), (32) of the computer host (2), (3), including the remaining computer host 4, etc. The control ship (24), (34) is connected to the transformer (25), (35) via the regulated and rectified direct current output cable (26), (36), and indirectly connected to the motherboard (27), (37).

Based on the structure mentioned above, the present invention is connected to the first computer host (2) with network cable (5) via power supplier (22) through motherboard (27) and control chip (24) so as to transmit network signals on the alternating current power cable (1). As long as the second and the third computer hosts (3), (4) and the remaining computer host are connected to the power supplier (32), (42) thereon, and thus connected to the alternating current power cable (1), direct Internet connection can be established.

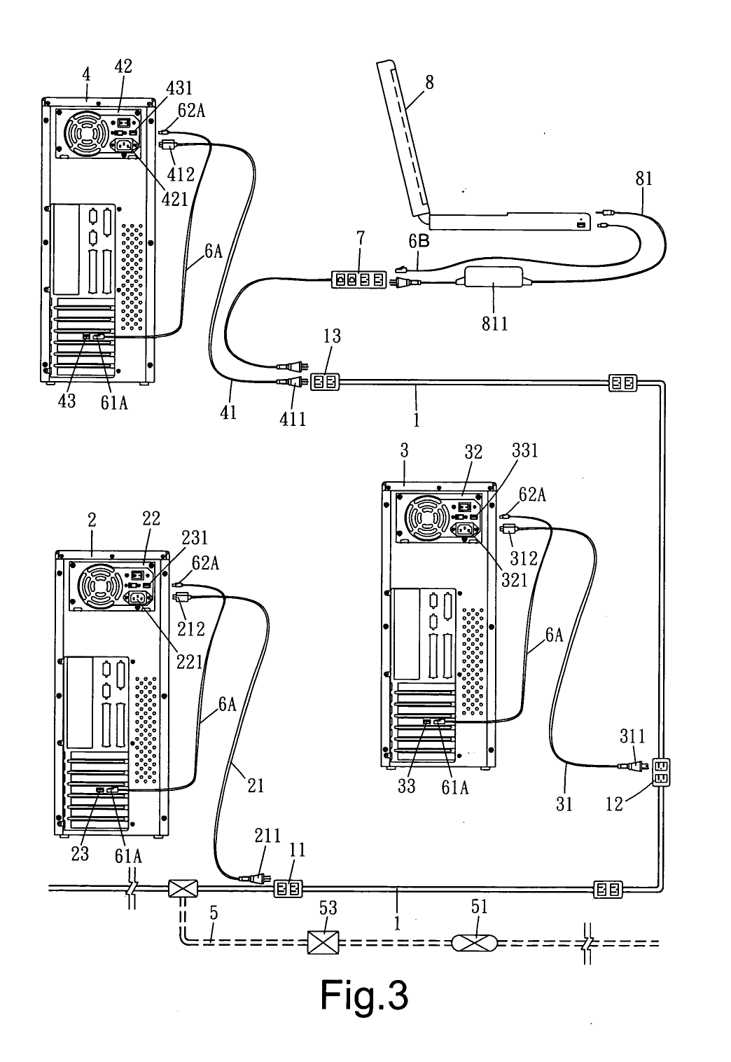

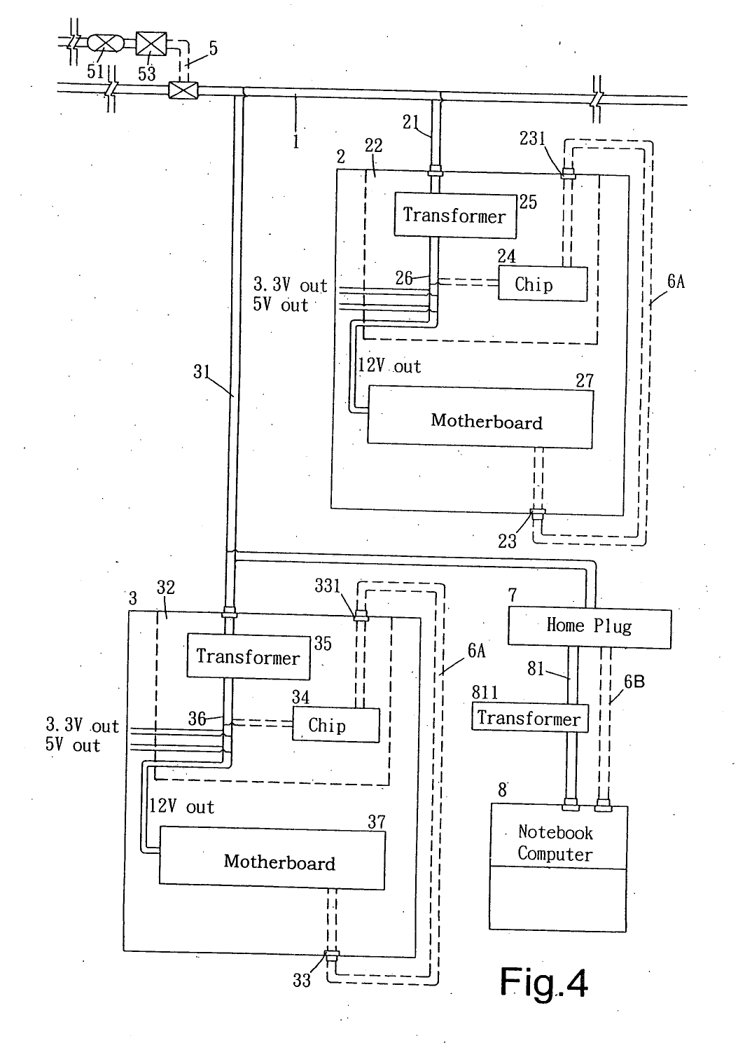

Refer to FIGS. 3 and 4, which illustrate another embodiment of the present invention. Network cable (5) with router (51) and home plug (53) connected at a front end is directly connected with the alternating current power cord (1). Network cable (6) can be ignored while the rest is configured according to the present invention described above, thereby establishing the network connection for respective computer host (2), (3), (4).

The power supply used by conventional notebook computer (8) utilizes the transformer (811) on the power cable (81) to first convert to direct current that is then used by the notebook computer (8). Therefore, in accordance with the present invention, a plug (13) at one end of the alternating current power cord (1) is extended with a home plug (7). The network cable (6B) and the power cable (81) with the transformer (811) are connected to the home plug (7) such that when the notebook computer (8) and the alternating current power cable (1) as well as the network cable (5) are connected, power supply and network connection functions can be achieved.

Refer to FIGS. 1 and 2. In accordance with the present invention, the computer host (2) connected with the network cable (5) transmits network signals over the alternating current power cable (1) via power supplier (22) through motherboard (27), control chip (24); as a result, the second and third computer hosts (3), (4) or any other computer host can directly connect to the Internet through the connection between the power supplier (32), (42) thereon and the alternating current power cord (1).

Additionally, refer to FIGS. 3 and 4. The network cable (5) with router (51) and home plug (53) provided at the front end can be connected to the alternating current power cord (1) such that the network cable (6) can be ignored. With the configuration of the present invention mentioned above, each respective computer host, (2), (3), (4) can be connected to the network. Through the home plug (7), the notebook computer (8) and the alternating current power cable (1) as well as the network cable (5) can be connected, thereby providing power supply and network connection functions.

1-3. (canceled)

4. An indoor power cord network transmission device comprising:
a) an alternating current power cord;
b) at least two host computers, each of the at least two host computers having:
i) a motherboard;
ii) a power supplier having a control chip, a transformer, a power supply network connector and a regulated and rectified direct current output cable, the control chip is connected to the transformer by the regulated and rectified direct current output cable and is indirectly connected to the mother board;
iii) at least one first network plug;
iv) a first network cable connecting the at least one first network plug to the power supply network connector of the power supplier; and
v) a power cord connecting the power supplier to the alternating current power cord; and
c) a second network cable having a router, wherein signals from the at least two host computers and the router are transmitted over the alternating current power cord.

5. The indoor power cord network transmission device according to claim 4, wherein the second network cable has a network power connector connected directly to the alternating current power cord.

6. The indoor power cord network transmission device according to claim 4, wherein the at least two host computers includes a primary host computer having a second network plug, the second network cable has a connector connected to the second network plug of the primary host computer, the primary host computer transmitting the signals over the alternating current power cord to the at least two host computers via a device selected from the mother board and the control chip of the primary host computer.

7. The indoor power cord network transmission device according to claim 6, further comprising a third network cable connected between the second network plug of the primary host computer and the connector of the second network cable.

8. The indoor power cord network transmission device according to claim 6, wherein the second network plug is connected to the motherboard of the primary host computer.

9. The indoor power cord network transmission device according to claim 6, wherein the at least two host computers includes three host computers.

10. The indoor power cord network transmission device according to claim 4, wherein the control chip is connected to the motherboard by the first network cable.

11. The indoor power cord network transmission device according to claim 4, wherein at least one first network plug is connected to the motherboard.

12. The indoor power cord network transmission device according to claim 4, further comprising a hand-held computer and a network power connector, the hand-held computer having a hand-held network cable and a hand-held power cord having a transformer, the network power connector is connected to the alternating current power cord, the hand-held network cable is connected at opposing ends thereof to the hand-held computer and the network power connector, and the hand-held power cord is connected at opposing ends thereof to the hand-held computer and the network power connector.
